(19) United States
(12) Patent Application Publication
(10) Pub. No.: US 2022/0173952 A1
(43) Pub. Date: Jun. 2, 2022

(54) MODULATION SYSTEM AND MODULATION METHOD FOR MODULATING A SATELLITE UPLINK SIGNAL

(71) Applicant: Rohde & Schwarz GmbH & Co. KG, Munich (DE)

(72) Inventor: Mathias Erhard, Munich (DE)

(73) Assignee: Rohde & Schwarz GmbH & Co. KG, Munich (DE)

(21) Appl. No.: 17/492,153

(22) Filed: Oct. 1, 2021

(30) Foreign Application Priority Data
Dec. 2, 2020 (EP) 20211238.9

(51) Int. Cl. H04L 27/26; H04B 7/185; H04W 72/04

(52) U.S. Cl. CPC H04L 27/2655; H04W 72/0413; H04B 7/18589; H04B 7/18526

(57) ABSTRACT

A modulation system for modulating a satellite uplink signal is described. The modulation system includes at least one computer device that includes an input interface, at least one software modulation engine, and at least one processing circuit. The input interface is configured to receive at least one input signal. The software modulation engine includes program code that is configured to modulate the at least one input signal when the software modulation engine is executed on the at least one processing circuit, thereby generating at least one IQ baseband data carrier (IQBBDC) signal based on the at least one input signal. Further, a modulation method for modulating a satellite uplink signal is described.

### FIELD OF THE DISCLOSURE

Embodiments of the present disclosure generally relate to a modulation system for modulating a satellite uplink signal. Embodiments of the present disclosure further relate to a modulation method for modulating a satellite uplink signal.

### BACKGROUND

Modulation systems for modulating a satellite uplink signal usually comprise several hardware modulators that modulate one or several input signals. The corresponding modulated signals are merged into a single central frequency band, for example into the L-band.

The merged signal is usually converted into an optical signal by an RF-to-optical converter, and the optical signal is transmitted to the target location (for example an antenna for satellite communication) by optical cables. The optical signal is converted back into the L-band at the target location, and is up-converted into the actual transmission band, e.g. the Ku-band.

Thus, there are several signal conversion steps, which comprise an RF-to-optical conversion and an optical-to-RF conversion. The corresponding converters and the optical cables are rather costly and thus raise the manufacturing costs (capital expenditure—CAPEX) as well as the operational costs (operational expenditure—OPEX) of such modulation systems.

Thus, there is a need to provide a modulation system for modulating a satellite uplink signal that is more cost-efficient.

### SUMMARY

Embodiments of the present disclosure provide a modulation system for modulating a satellite uplink signal. In an embodiment, the modulation system comprises at least one computer device. The at least one computer device comprises an input interface, at least one software modulation module or engine, and at least one processing unit, such as a central processing unit (CPU), a microprocessor, a processor circuit, a graphical processing unit (GPU), etc. The input interface is configured to receive at least one input signal. The software modulation module comprises program code, executable instructions, or other means that are configured to modulate the at least one input signal when the software modulation module is executed on the at least one processing unit, thereby generating at least one IQ baseband data carrier (IQBBDC) signal based on the at least one input signal.

Therein, the at least one input signal may be associated with a data stream, such as an audio stream and/or a video stream, that is to be transmitted via satellite. In some embodiments, the at least one input signal may be associated with a television signal that is to be transmitted via satellite. For example, the modulation system may be established as a DVB-Sx modulation system.

The present disclosure is based on the idea to modulate the at least one input signal by the software modulation module instead of using hardware modulators as in the state-of-the-art, thereby reducing the costs, for example CAPEX and/or OPEX.

Accordingly, the at least one IQBBDC signal is a digital signal that can be transmitted to a target destination, e.g. to an antenna for satellite communication, without a prior conversion to an optical signal. For example, usual Ethernet components may be used for transmitting the at least one IQBBDC signal, which are considerably less expensive than their optical counterparts are.

As no RF-to-optical converters and no optical-to-RF converters are necessary for transmitting the at least one IQBBDC signal to the target location, the modulation system according to the present disclosure can be manufactured at a reduced cost.

Moreover, embodiments of the modulation system according to the present disclosure can easily be up-scaled by providing several copies of the software modulation module, which may be executed on the at least one processing unit or on several processing units.

The computer device may comprise a memory, and the at least one software modulation module may be saved in the memory.

According to an aspect of the present disclosure, the computer device is established as a server. The server may be part of a user-side network or of an external network, for instance a wide area network (WAN) and/or a local area network (LAN). In some embodiments, the server may be part of a computational cloud, such that the user of the modulation system does not have to purchase its own server.

According to another aspect of the present disclosure, the computer device comprises several software modulation modules and/or several processing units, wherein the several software modulation modules and/or the several processing units are configured to generate at least two different IQBBDC signals based on the at least one input signal. For example, the computer device may receive several input signals and may generate a respective IQBBDC signal for each of the input signals. Alternatively or additionally, the software modulation module may generate multiple IQBBDC signals based on a single input signal.

In an embodiment of the present disclosure, the modulation system comprises an amplifier module, comprised of for example at least one amplifier, and a connecting interface, wherein the connecting interface connects the computer device with the amplifier module, and wherein the connecting interface is configured to transmit the at least one IQBBDC signal from the computer device to the amplifier module.

Therein and in the following, the term “connecting interface” is understood to comprise all hardware and software means that are necessary in order to transmit the at least one IQBBDC signal from the computer device to the amplifier module. Accordingly, the connecting interface may comprise corresponding network cards, connecting cables, and connectors for connecting the cables to the computer device and to the amplifier module.

In a further embodiment of the present disclosure, the connecting interface is configured to transmit the at least one IQBBDC signal based on a packet-oriented protocol. For example, the connecting interface is configured to transmit the at least one IQBBDC signal based on Ethernet10G, Ethernet100G, and/or VITA49.2. Of course, any other suitable transmission protocol for transmitting digital data may be used as well.

The connecting interface may be configured to convert the at least one IQBBDC signal based on the used transmission protocol on the computer-device side in order to transmit the at least one IQBBDC signal from the computer device to the amplifier module. The connecting interface may further be configured to convert the transmitted signal back to the original IQBBDC signal on the amplifier module-side.

According to another aspect of the present disclosure, the connecting interface is configured to transmit several IQBBDC signals individually. In other words, the individual IQBBDC signals may not be merged into a single signal, but are transmitted independent from each other. Thus, an individual target destination may be chosen for each IQBBDC signal, as the individual IQBBDC signals are not merged with each other. In some embodiments, the individual IQBBDC signals may be transmitted via one or several cables that connect the computer device with one or several IQBBDC signal destination(s).

In a further embodiment of the present disclosure, the amplifier module comprises a mixer module, wherein the mixer module comprises at least one mixer being configured to up-convert the at least one IQBBDC signal to an intermediate frequency, thereby generating an intermediate frequency signal. In general, the intermediate frequency signal has a predefined frequency range, wherein the predefined frequency range is associated with a transmission frequency range that is allocated to the respective IQBBDC signal.

The mixer module may comprise at least one local oscillator signal input that is configured to receive a local oscillator signal. The at least one mixer may be configured to up-convert the at least one IQBBDC signal to the intermediate frequency by mixing the IQBBDC signal with the local oscillator signal.

Moreover, the mixer module may comprise at least one filter being associated with the at least one mixer, wherein the filter is configured to remove unwanted frequency components from the intermediate frequency signal.

In some embodiments, the intermediate frequency signal is established as a digital signal. Accordingly, the local oscillator signal may be established as a numerically controlled oscillator signal. Moreover, the at least one filter may be established as or include a digital filter.

In some embodiments, the mixer module comprises at least one gain unit being associated with the at least one mixer, wherein the at least one gain unit includes, for example, circuitry configured to adapt a gain of the at least one IQBBDC signal. In other words, the at least one gain unit is configured to adapt a signal level of the at least one IQBBDC signal, such that the signal level of the at least one IQBBDC signal is appropriate for subsequent processing steps, for example appropriate for the subsequent processing steps that are described in more detail below.

The at least one gain unit may be provided upstream of the at least one mixer.

According to an aspect of the present disclosure, the mixer module comprises several mixers, the several mixers being associated with different IQBBDC signals. In some embodiments, the mixer module may comprise a mixer for each IQBBDC signal received from the computer device. Thus, each IQBBDC signal may be up-converted to a different intermediate frequency by the several mixers, for example according to a transmission frequency plan comprising designated frequency bands for each IQBBDC signal.

According to another aspect of the present disclosure, the mixer module comprises a summation unit, wherein the summation unit is configured to sum the intermediate frequency signals generated by the several mixers, thereby generating an aggregated multi-carrier sum signal. Thus, the aggregated multi-carrier sum signal comprises all of the intermediate frequency signals. However, the intermediate frequency signals may have frequency ranges that are different from each other, such that the individual intermediate frequency signals can still be extracted from the aggregated multi-carrier sum signal by appropriate (frequency) filtering.

The aggregated multi-carrier sum signal may also be denoted as an up-mixed sum signal.

Since the amplifier module comprises the mixer module, the amplifier module is configured to digitally aggregate the intermediate frequency signals into the aggregated multi-carrier sum signal, namely the up-mixed sum signal.

In a further embodiment of the present disclosure, the amplifier module comprises an IQ modulation unit or modulator, wherein the IQ modulation unit is configured to up- convert the aggregated multi-carrier sum signal to a target transmission frequency band, thereby generating a transmission signal. In general, the target transmission frequency band corresponds to a frequency band that is suitable for wireless transmission of the transmission signal to a satellite. In some embodiments, the target transmission band may be the Ku-band. However, it is to be understood that the aggregated multi-carrier sum signal may be up-converted to any other frequency band that is suitable for wireless transmission to a satellite.

The amplifier module may comprise an amplifier, wherein the amplifier is configured to amplify the transmission signal, for example wherein the amplifier is established as a high-power amplifier. In other words, the amplifier unit raises a signal level of the transmission signal to a signal level that is suitable for wireless transmission of the transmission signal to a satellite.

According to an aspect of the present disclosure, the amplifier module comprises a digital-to-analog converter upstream of the IQ modulation unit, wherein the digital-to-analog converter is configured to convert the aggregated multi-carrier sum signal into an analog aggregated multi-carrier sum signal. Thus, the IQ modulation unit is established as an analog modulation unit. The IQ modulation unit is configured to modulate the analog aggregated multi-carrier sum signal, thereby generating an analog transmission signal.

Moreover, the amplifier unit described above may be configured to amplify the analog transmission signal.

According to another aspect of the present disclosure, the amplifier module comprises a pre-distortion filter upstream of the IQ modulation unit, wherein the pre-distortion filter is configured to filter the aggregated multi-carrier sum signal based on a predefined spectrum mask. The pre-distortion filter may remove unwanted distortion components from the aggregated multi-carrier sum signal. Moreover, the pre-distortion filter may shape the aggregated multi-carrier sum signal according to a predefined specification, for example according to a predefined customer specification. Hence, the pre-distortion filter is located downstream of the summation unit that generates the aggregated multi-carrier sum signal.

The pre-distortion filter may be provided upstream of the digital-to-analog converter described above.

Embodiments of the present disclosure further provide a modulation method for modulating a satellite uplink signal. In an embodiment, the modulation method comprises the following steps:
providing a computer device, the computer device comprising an input interface, at least one software modulation module, and at least one processing circuit;
receiving at least one input signal by the input interface;
modulating the at least one input signal by executing the at least one software modulation module on the at least one processing circuit, thereby generating at least one IQ baseband data carrier (IQBBDC) signal based on the at least one input signal.

In some embodiments, the modulation system described above is configured to perform the modulation method.

Regarding the advantages and further properties of the modulation method, reference is made to the explanations given above with respect to the modulation system, which also hold for the modulation method and vice versa.

According to an aspect of the present disclosure, the computer device comprises several software modulation modules and/or several processing circuits, wherein the several software modulation modules and/or the several processing circuits are configured to generate at least two different IQBBDC signals based on the at least one input signal.

According to another aspect of the present disclosure, the computer device comprises several software modulation modules, wherein the at least one input signal is modulated by executing the several software modulation modules on the at least one processing unit, thereby generating at least two different IQBBDC signals based on the at least one input signal.

In an embodiment of the present disclosure, the computer device comprises several processing circuits, wherein the at least one input signal is modulated by executing the at least one software modulation module on the several processing circuits, thereby generating at least two different IQBBDC signals based on the at least one input signal.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a representative modulation system according to an embodiment of the present disclosure; and

FIG. 2 shows a flow chart of a representative modulation method according to an embodiment of the present disclosure.

### DETAILED DESCRIPTION

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps.

In the description provided below, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value.

Throughout this specification, terms of art may be used. These terms are to take on their ordinary meaning in the art from which they come, unless specifically defined herein or the context of their use would clearly suggest otherwise.

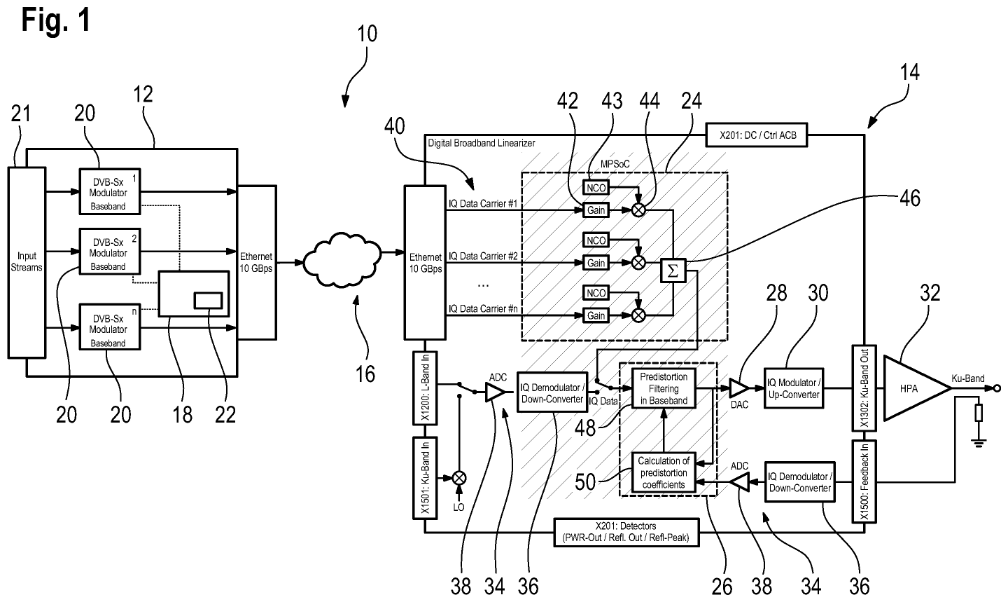

FIG. 1 schematically shows a modulation system 10 for modulating a satellite uplink signal. As shown in FIG. 1, the modulation system 10 comprises a computer device 12, an amplifier module 14, and a connecting interface 16 that is located between the computer device 12 and the amplifier module 14.

In some embodiments, the term “module” refers to or includes, inter alia, a combination of hardware (e.g. a processor such as an integrated circuit, digital circuits or other circuitry) and software (e.g. machine- or processor-executable instructions, commands, or code such as firmware, programming, or object code). Furthermore, a combination of hardware and software may include hardware only (i.e. a hardware element with no software elements), software hosted at hardware (e.g. software that is stored at a memory and executed or interpreted at a processor), or hardware with the software hosted thereon. In some embodiments, the hardware may, inter alia, comprise a CPU, a GPU, an FPGA, an ASIC, or other types of electronic circuitry.

The computer device 12 and the amplifier module 14 are connected to each other in a signal transmitting manner by the connecting interface 16. Therein and in the following, the term “connecting interface” is understood to comprise all hardware and software means, such as interface circuitry, that are necessary in order to transmit signals from the computer device 12 to the amplifier module 14. Accordingly, the connecting interface 16 may comprise corresponding network cards, connecting cables, and connectors for connecting the cables to the computer device 12 and to the amplifier module 14.

In some embodiments, the computer device 12 is established as a server, sometimes referred to as a server computer. The server may be part of a user-side network or of an external network, for instance a wide area network (WAN) and/or a local area network (LAN). In some embodiments, the computer device 12 may be part of a computational cloud.

The computer device 12 comprises a memory 18, several processing circuits or units 20 that are connected to the memory 18, and an input interface 21. The several processing units 20 may be established as different processor circuits and/or as different cores of a single processor circuit. In some embodiments, the processing units 20 may be or include any processing structure, including but not limited to a processor (e.g., a microprocessor), a central processing unit (CPU), a digital signal processor (DSP), graphics processing unit (GPU), an application-specific integrated circuit (ASIC), a field-programmable gate array (FPGA), a system on a chip (SoC), or the like, or any combinations thereof.

The memory 18 is configured to store at least one software modulation engine or module 22. The memory may include non-transitory computer-readable storage media, which may include all computer-readable media (including volatile and non-volatile media). For example, in one embodiment, a non-volatile computer-readable storage medium may include optical disk, hard disk, solid-state storage (SSS) (e.g., a solid state drive (SSD), solid state card (SSC), magnetic tape, or any other non-transitory magnetic medium, read-only memory (ROM), programmable read-only memory (PROM), erasable programmable read-only memory (EPROM), electrically erasable programmable read-only memory (EEPROM), flash memory (e.g., Serial, NAND, NOR, and/or the like), or the like. In some embodiment, volatile computer-readable storage medium may include random access memory (RAM), dynamic random access memory (DRAM), static random access memory (SRAM), synchronous dynamic random access memory (SDRAM) of any rate, cache memory (including various levels), flash memory, register memory, and/or the like. It will be appreciated that where embodiments are described or claimed to use a computer-readable storage media, other types of computer-readable storage media may be substituted for or used in addition to the computer-readable storage media described above.

In some embodiments, the computer-readable media also includes cooperating or interconnected computer-readable media, which exist exclusively on a processing system or distributed among multiple interconnected processing systems that may be local to, or remote from, the processing system.

In some embodiments, the software modulation engine or module 22 may include applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). The engine can be stored in any type of computer-readable medium or computer storage device and be stored on and executed by one or more general purpose computers or processor circuits, thus creating a special purpose computer configured to provide the engine or the functionality thereof.

The functionality of the software modulation module 22 will be described in more detail below.

Still referring to FIG. 1, the amplifier module 14 comprises a mixer circuit or module 24, a filter circuit or module 26, a digital-to-analog converter 28, an IQ modulation circuit or unit 30, and an amplifier 32. The amplifier module 14 may further comprise a feedback circuit or module 34 with at least one IQ demodulation circuit or unit 36 and at least one analog-to-digital converter 38 being associated with the at least one IQ demodulation unit 36.

The mixer module 24 comprises several mixing channels 40. Each of the mixing channels 40 comprises a gain circuit or unit 42, a local oscillator input 43, and a mixer 44. The mixer module 24 further comprises a summation circuit or unit 46 that is connected to each of the mixers 44.

The filter module 26 comprises, for example, a pre-distortion filter 48 and a coefficient circuit or module 50, wherein the coefficient module 50 is configured to adapt filter parameters of the pre-distortion filter 48. The pre-distortion filter 48 is connected to the summation unit 46 downstream of the summation unit 46.

The digital-to-analog converter 28 is connected to the pre-distortion filter 48 downstream of the pre-distortion filter 48. The IQ modulation unit 30 is connected to the digital-to-analog converter 28 downstream of the digital-to-analog converter 28. The amplifier 32 is connected to the IQ modulation unit 30 downstream of the IQ modulation unit 30.

In general, the modulation system 10 is configured to receive input signals that are associated with a respective data stream, for example a respective audio stream, video stream and/or digital television stream. The modulation system 10 further is configured to modulate the received input signals such that they are adapted for wireless transmission to a satellite.

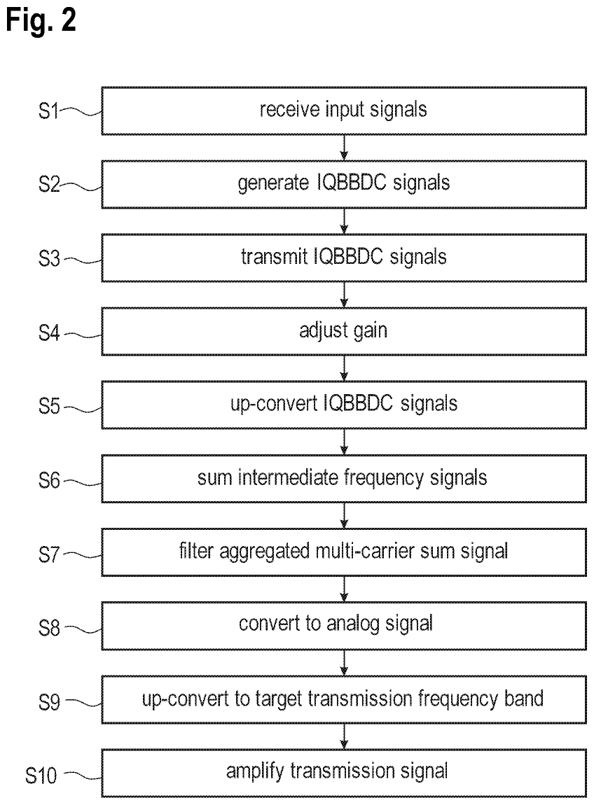

In some embodiments, the modulation system 10 is configured to perform a modulation method for modulating a satellite uplink signal, an example of which is described in the following with reference to FIG. 2.

Several input signals are received by the computer device 12, more precisely by the input interface 21 of the computer device 12 (step 51).

Each of the input signals is associated with a data stream, such as an audio stream and/or a video stream, that is to be transmitted via satellite. In some embodiments, the input signals are associated with a digital television signal that is to be transmitted via satellite. Each of the several input signals is forwarded to one of the processing units 20, respectively.

The input signals are modulated by the at least one software modulation module 22, thereby generating a respective IQ baseband data carrier (IQBBDC) signal based on each of the input signals (step S2).

For example, the at least one software modulation module 22 comprises program code that is configured to modulate the received input signals when the software modulation module 22 is executed on the processing units 20.

The IQBBDC signals are transmitted to the amplifier module 14 by the connecting interface 16 (step S3).

In some embodiments, the IQBBDC signals are transmitted from the computer device 12 to the amplifier module 14 individually. In other words, the individual IQBBDC signals may not be merged into a single signal, but are transmitted independent from each other.

In general, the connecting interface 16 transmits the IQBBDC signals based on a packet-oriented protocol. For example, the connecting interface 16 transmits the IQBBDC signals based on EthernetlOG, Ethernet100G, and/or VITA49.2. Of course, any other suitable transmission protocol for transmitting digital data may be used as well.

The connecting interface 16 may be configured to convert the IQBBDC signals based on the used transmission protocol on the computer-device side in order to transmit the IQBBDC signals from the computer device 12 to the amplifier module 14. The connecting interface 16 may further be configured to convert the transmitted signals back to the original IQBBDC signals on the amplifier module-side. Each of the received IQBBDC signals is forwarded to one of the mixing channels 40.

A respective gain of the received IQBBDC signal is adjusted by the gain units 42 (step S4).

Therein, the respective signal levels of the IQBBDC signals are adjusted as appropriate for the further processing steps described in the following.

The individual IQBBDC signals are up-converted to a respective intermediate frequency by the mixers 44, thereby generating a respective intermediate frequency signal based on each of the IQBBDC signals (step S5).

For example, the mixers 44 up-convert the IQBBDC signals to the respective intermediate frequency by mixing the IQBBDC signal with a (numerically controlled) local oscillator signal received by the local oscillator input 43.

In general, the intermediate frequency signals each have a predefined frequency range, wherein the predefined frequency range is associated with a transmission frequency band that is allocated to the respective IQBBDC signal. In some embodiments, each IQBBDC signal may be up-converted to a different intermediate frequency by the several mixers 44, for example according to a transmission frequency plan.

The intermediate frequency signals are summed by the summation unit 46, thereby generating an aggregated multi-carrier sum signal (step S6).

The aggregated multi-carrier sum signal is forwarded to the filter module 26, for example to the pre-distortion filter 48.

The aggregated multi-carrier sum signal is filtered by the pre-distortion filter 48 based on a pre-defined spectrum mask, thereby generating a filtered multi-carrier sum signal (step S7).

The pre-defined spectrum mask may be configured such that the pre-distortion filter 48 removes unwanted distortion components from the aggregated multi-carrier sum signal. Alternatively or additionally, the pre-defined spectrum mask may be configured such that the pre-distortion filter 48 shapes the aggregated multi-carrier sum signal according to a predefined specification, for example according to a predefined customer specification. The filtered multi-carrier sum signal is forwarded to the digital-to-analog converter 28.

The digital-to-analog converter 28 converts the filtered multi-carrier sum signal into an analog signal, thereby generating an analog multi-carrier sum signal (step S8).

The analog multi-carrier sum signal is forwarded to the IQ modulation unit 30.

The analog multi-carrier sum signal is up-converted to a target transmission frequency band by the IQ modulation unit 30, thereby generating a transmission signal (step S9).

In general, the target transmission frequency band corresponds to a frequency band that is suitable for wireless transmission of the transmission signal to a satellite. In some embodiments, the target transmission band may be the Ku-band. However, it is to be understood that the analog multi-carrier sum signal may be up-converted to any other frequency band that is suitable for wireless transmission to a satellite. The transmission signal is forwarded to the amplifier 32.

The transmission signal is amplified by the amplifier 32, thereby generating an amplified transmission signal (step S10).

In general, the amplifier 32 raises a signal level, i.e., a power level of the transmission signal, to a signal level that is suitable for wireless transmission of the transmission signal to a satellite. The amplified transmission signal may be forwarded to an antenna or an antenna array for transmission to one or several satellites.

Optionally, the feedback module 34 may receive feedback signals from the satellite or from the antenna. The feedback signals may be forwarded to the coefficient module 50, for example after a demodulation by the at least one IQ demodulation unit 36 and an analog- to-digital conversion by the at least one analog-to-digital converter 38.

The coefficient module 50 may adapt the filter coefficients of the pre-distortion filter 48, i.e., the spectrum mask of the pre-distortion filter, based on the feedback signals received.

With the modulation system 10 described above, the IQBBDC signals can be transmitted to the target destination, i.e., to the amplifier module 14, without a prior conversion to an optical signal. For example, usual Ethernet components may be used for transmitting the IQBBDC signals, which are considerably less expensive than their optical counterparts are. As no RF-to-optical converters and no optical-to-RF converters are necessary for transmitting the IQBBDC signals to the target location, the modulation system 10 described above can be manufactured at a reduced cost. Moreover, the modulation system 10 described above can easily be up-scaled by providing several copies of the software modulation module 22, which may be executed on the processing units 20 of the computer device 12, and/or by providing more processing units 20 in the computer device 12.

Various embodiments disclosed herein include components, such as modules, units, etc., that utilize circuitry (e.g., one or more circuits) in order to implement protocols, methodologies or technologies disclosed herein, operably couple two or more components, generate information, process information, analyze information, generate signals, encode/decode signals, convert signals, modulate and/or demodulate signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions, program code, etc., stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

Throughout this specification, terms of art may be used. These terms are to take on their ordinary meaning in the art from which they come, unless specifically defined herein or the context of their use would clearly suggest otherwise.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A modulation system for modulating a satellite uplink signal, the modulation system comprising:
at least one computer device, the at least one computer device comprising an input interface, at least one software modulation engine, and at least one processing circuit,
wherein the input interface is configured to receive at least one input signal,
wherein the software modulation engine comprises program code that is configured to modulate the at least one input signal when the software modulation engine is executed on the at least one processing circuit, thereby generating at least one IQ baseband data carrier (IQBBDC) signal based on the at least one input signal.

2. The modulation system of claim 1, wherein the computer device includes a server computer.

3. The modulation system according to claim 1, wherein the computer device comprises several software modulation engines and/or several processing circuits, wherein the several software modulation engines and/or the several processing circuits are configured to generate at least two different IQBBDC signals based on the at least one input signal.

4. The modulation system according to claim 1, further comprising an amplifier module comprising one or more circuits and a connecting interface comprising one or more circuits, wherein the connecting interface connects the computer device with the amplifier module, and wherein the connecting interface is configured to transmit the at least one IQBBDC signal from the computer device to the amplifier module.

5. The modulation system of claim 4, wherein the connecting interface is configured to transmit the at least one IQBBDC signal based on a packet-oriented protocol.

6. The modulation system of claim 4, wherein the connecting interface is configured to transmit several IQBBDC signals individually.

7. The modulation system of claim 4, wherein the amplifier module comprises a mixer module, wherein the mixer module comprises at least one mixer being configured to up-convert the at least one IQBBDC signal to an intermediate frequency, thereby generating an intermediate frequency signal.

8. The modulation system of claim 7, wherein the mixer module comprises at least one gain circuit being associated with the at least one mixer, wherein the at least one gain circuit is configured to adapt a gain of the at least one IQBBDC signal.

9. The modulation system of claim 7, wherein the mixer module comprises several mixers, the several mixers being associated with different IQBBDC signals.

10. The modulation system according to claim 9, wherein the mixer module comprises a summation circuit, wherein the summation circuit is configured to sum the intermediate frequency signals generated by the several mixers, thereby generating an aggregated multi-carrier sum signal.

11. The modulation system according to claim 10, wherein the amplifier module comprises an IQ modulation circuit, wherein the IQ modulation circuit is configured to up-convert the aggregated multi-carrier sum signal to a target transmission frequency band, thereby generating a transmission signal.

12. The modulation system according to claim 11, wherein the amplifier module comprises an amplifier configured to amplify the transmission signal.

13. The modulation system according to claim 12, wherein the amplifier includes a high-power amplifier.

14. The modulation system according to claim 11, wherein the amplifier module comprises a digital-to-analog converter upstream of the IQ modulation circuit, wherein the digital-to-analog converter is configured to convert the aggregated multi-carrier sum signal into an analog aggregated multi-carrier sum signal.

15. The modulation system according to claim 11, wherein the amplifier module comprises a pre-distortion filter upstream of the IQ modulation circuit, wherein the pre-distortion filter is configured to filter the aggregated multi-carrier sum signal based on a predefined spectrum mask.

16. A modulation method for modulating a satellite uplink signal, the modulation method comprising the following steps:
providing a computer device, the computer device comprising an input interface, at least one software modulation engine, and at least one processing circuit;
receiving at least one input signal by the input interface;
modulating the at least one input signal by executing the at least one software modulation engine on the at least one processing circuit, thereby generating at least one IQ baseband data carrier (IQBBDC) signal based on the at least one input signal.

17. The modulation method of claim 16, wherein the computer device comprises several software modulation engines and/or several processing circuits, wherein the several software modulation engines and/or the several processing circuits are configured to generate at least two different IQBBDC signals based on the at least one input signal.

18. The modulation method of claim 16, wherein the computer device comprises several software modulation engines, wherein the at least one input signal is modulated by executing the several software modulation engines on the at least one processing circuit, thereby generating at least two different IQBBDC signals based on the at least one input signal.

19. The modulation method of claim 16, wherein the computer device comprises several processing circuits, wherein the at least one input signal is modulated by executing the at least one software modulation engine on the several processing circuits, thereby generating at least two different IQBBDC signals based on the at least one input signal.
